(19) United States
(12) Patent Application Publication
(10) Pub. No.: US 2014/0211486 A1
(43) Pub. Date: Jul. 31, 2014

(54) HEAT EXCHANGER FOR LED LIGHT FIXTURE

(71) Applicant: Edward T. Rodriguez, Wakefield, MA (US)

(72) Inventor: Edward T. Rodriguez, Wakefield, MA (US)

(21) Appl. No.: 13/754,788

(22) Filed: Jan. 30, 2013

(51) Int. Cl. F21V 29/00; F21V 29/02

(52) U.S. Cl. CPC F21V 29/22; F21V 29/027
USPC 362/373

(57) ABSTRACT

A heat exchange system for an LED light fixture is provided. The heat exchange system includes an enclosure 4, a heat sink 9 positioned inside of and spaced apart from said enclosure 4, and a fan positioned inside of and spaced part from said enclosure 4. Heat is first transferred from LEDs 1 to heat sink 9. Heat is then transferred from heat sink 9 to the air within said enclosure 4 aided by fan 10. Heat is then transferred from the air inside of enclosure 4 to said enclosure 4 and then to outside ambient air. The enclosure 4 may be open (unsealed) or closed (sealed from a surrounding environment). The heat exchange system may be constructed from relatively simple and inexpensive components.

### BACKGROUND OF THE INVENTION

1. Field of the Invention

This disclosure herein relates in general to thermal management system for a light fixture employing light emitting diodes (“LEDs”) as a light source and, more particularly, to a two stage heat exchanger for an LED light fixture.

2. Description of the Related Art

Those skilled in the design of lamps and light fixtures for general illumination are aware that LEDs are increasingly being used to replace traditional light sources using filament or gaseous-discharge technologies. Such LED lamps or light fixtures (collectively “light fixtures”) typically employ a single LED, a number of LEDs closely arranged in an array to form a single package or single, a dispersed array of LEDs or LED packages. The LEDs or LED packages may be surface mounted to a metal core circuit board (“MCB”) or may be mounted by other well-known mechanical means. LED light sources are also available in arrangements referred to as “modules” or “light engines” which may include additional driver and power supply and driver circuitry, mounting structure, and thermal management components such as heat sinks and fans. As used herein, “LED” and “LEDs” may include reference to any form of LED mounting or packaging.

When energized to produce light, LEDs produce heat. If that heat is not dissipated, the performance and life of the LEDs may suffer. In addition, in the case where a phosphor is used to convert blue LED light to white light, excessive heat may be deleterious to the phosphor.

Typically LED lighting devices employ heat sinks, usually made of metal and most commonly of aluminum, to dissipate the heat from the LEDs and ultimately to transfer the heat to the environment, usually ambient air. Some LED lighting devices employ fans or other apparatus to assist in the dissipation of the heat generated by the LEDs by moving air around, through, and/or past the heat sinks or other parts of the lighting fixture. The techniques for dissipation of the heat generated by LEDs are sometimes broadly referred to as “thermal management.” If such a system uses only heat sinks, it may be referred to as “passive cooling” and if it uses an auxiliary device such as a fan, it may be referred to as “active cooling.”

Heat sink components are usually made of aluminum and, for higher wattages, cast aluminum. The casting process can carry a 20-40% penalty in weight and size to achieve thermal conductivity parity with the higher purity extrusion or formed-aluminum processes. For high wattage light fixtures, the material cost, shipping cost, tooling cost, fabrication cost and lead times for heat sink components, especially those of cast aluminum, can make light fixtures more costly. In addition, the size and weight of the thermal management components for high power light fixtures can be substantial, creating aesthetic challenges as well as installation challenges. In particular, common fin or pin structure of heat sinks often spoil aesthetics and also may be less than optimal with respect to dirt and debris build up.

The size and weight of passive cooling heat sinks relative to heat exchange effectiveness is significantly dependent on the exact configuration of the heat sink. As a rule of thumb, one can assume the size and weight increases almost exponentially as a function of power. That is, a 100 watt LED light fixture may require about four times the size and weight of heat sink than a 50 watt LED light fixture and a 200 watt system may require about sixteen times the size and weight of heat sink than a 50 watt light fixtures. In practice, engineers have learned techniques to modify the exponential characteristic but the increase in size and weight still generally follows the foregoing rule of thumb. For light fixtures operating at 10 to 20 watts, the size and weight issues may not be significant, but for LED light fixtures above 50 watts, the size, weight, and cost of the heat sink may present significant challenges.

It is fairly well known that moving air in an active cooling thermal management system can substantially increase the effectiveness of heat sinks and thereby greatly reduce the size and weight of the heat sink required for a given power level or wattage. Such size and weight reduction can have positive secondary effects of reducing overall size, reducing weight, reducing fabrication cost of the light fixture, permitting a wider range of aesthetic design, simplifying assembly and installation, and greatly reducing shipping costs. Notwithstanding the benefits of active cooling thermal management systems, the LED lighting industry has been slow to adopt such systems, perhaps because of perceptions or misperceptions concerning fan noise, fan reliability, and dirt and dust accumulation due to the operation of the fan. Thus, an improved cooling system for LED light fixtures is needed. Preferably, the improved cooling system provides for reductions in size, weight and cost of manufacture.

### BRIEF SUMMARY OF THE INVENTION

In one embodiment, a heat exchange system for a light emitting diode (LED) light fixture is disclosed. The system includes: an enclosure at least partially surrounding at least one LED; a heat sink positioned inside of and spaced apart from said enclosure, the heat sink configured to transfer heat away from the at least one LED; and a fan positioned inside of and spaced part from said enclosure, the fan configured to transfer heat away from the heat sink.

In another embodiment, a thermal management system for a light emitting diode (LED) light fixture is disclosed. The system includes: a first heat exchanger to remove heat from LEDs to air within an enclosure that at least partially surrounds the LEDs; and, a second heat exchanger to transfer heat from the air within the enclosure to air outside of said enclosure.

In an additional embodiment, a heat exchange system for an LED light fixture is provided area. The system includes: an enclosure including a peripheral wall that includes a pleated structure; a heat sink positioned inside of and spaced apart from the enclosure; a fan positioned inside of and spaced part from the enclosure and mounted one of on and proximal to a first side of the heat sink; and, a baffle positioned inside of and spaced part from the enclosure and positioned one of proximal and abutting to the fan on the first side of the fan; wherein heat exchange system is closed from an external environment.

### BRIEF DESCRIPTION OF THE DRAWINGS

The features and advantages of the invention are apparent from the following description taken in conjunction with the accompanying drawings in which:

FIG. 1 is a simplified schematic cross-sectional side view of an embodiment of a heat exchange system according to the teachings herein;

FIG. 2 is a top perspective view of the embodiment of the system shown in FIG. 1;

FIG. 3 is a bottom perspective view of the embodiment of the system shown in FIGS. 1 and 2;

FIG. 4 is a schematic axial cross-sectional view of the embodiment shown in FIGS. 1-3;

FIG. 5 is a schematic axial cross-sectional view of the embodiment shown in FIG. 4 showing a general pattern for airflow within the enclosure;

FIG. 6 is a perspective view of a pin-type heat sink that may be used in embodiments of the heat exchange system;

FIG. 7 is a perspective view of a fan that may be used in embodiments of the heat exchange system;

FIG. 8 is a perspective view of the heat sink (of FIG. 6) and fan (of FIG. 7) mated together;

FIG. 9 is a perspective top view and a perspective bottom view of a baffle that may be used in embodiments of the heat exchange system;

FIG. 10 is an exploded view of the heat sink (FIG. 6), fan (FIG. 7) and baffle (FIG. 8) mated together;

FIG. 11 is a perspective view the heat sink (FIG. 6), fan (FIG. 7) and baffle (FIG. 8) mated together;

FIG. 12 is a radial cross-sectional view of a peripheral wall of the enclosure shown in FIGS. 4 and 5, with a blown-up cross-sectional view of a portion of the peripheral wall;

FIG. 13 is a graph showing approximate relative power handling capacities of different thermal management systems including performance of a system provided according to the teachings herein;

FIG. 14 is an graph showing an exemplary and approximate relationship between enclosure area and thermal resistance to ambient air;

FIG. 15 is a graph showing and approximate relationship between enclosure weight and wattage for the compared cooling methods;

FIG. 16 is an axial cross-sectional view of an embodiment of the heat exchange system that includes supporting electronics; and,

FIG. 17 is a simplified electrical schematic illustrating exemplary electronics to drive and control the LEDs.

### DETAILED DESCRIPTION OF THE INVENTION

Disclosed herein is a heat exchange system that provides for dissipation of thermal energy (i.e., heat) in a lighting system that makes use of light emitting diodes (LEDs).

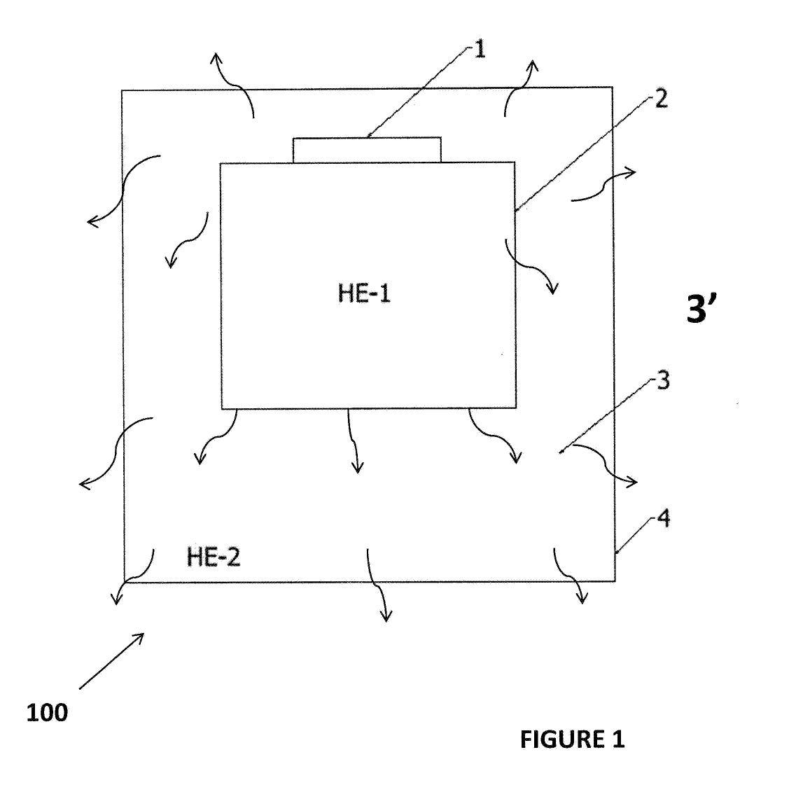

FIG. 1 shows a simplified schematic representation of an embodiment of a heat exchange system 100. In the heat exchange system 100, heat is first generated in and then transferred from LEDs 1 to cooling module 2 (HE-1). Cooling module 2 may include a heat sink and fan. Heat is then transferred from cooling module 2 to air 3 inside enclosure 4. Heat is then transferred from enclosure 4 (HE-2) to outside ambient air 3′. In an embodiment, enclosure 4 is closed (airtight or substantially airtight). In some embodiments, enclosure 4 may be vented. The heat exchange system 100 may be employed within a lighting fixture structure, such lighting fixture structure having aesthetic features and mounting features. The heat exchange system 100 may also serve as the exterior of a lighting fixture itself and, in such a case, without affecting performance, have aesthetic features and mounting features.

Examples of LEDs 1 that may be used with the heat exchange system 100 include, without limitation: BXRAN8300 00L0E and C1-L233-MC13LI-C made, respectively, by Bridgelux and Citizen.

Note that terms of orientation used herein (such as “top,” “bottom,” “up,” and “down”) are relative to the drawing figures and are not intended to limit the orientation of the respective apparatus in any way, such as during fabrication or use. Accordingly, it should be considered that such terminology is provided merely to aid in an understanding of the various diagrams presented herein.

FIG. 2 is a top perspective view of an embodiment of the heat exchange system 100. In this example, enclosure 4 is constructed with a peripheral wall 5, a top 6, and a bottom 7. Peripheral wall 5 is formed or configured to have a large surface area both on the inside and outside. In an exemplary embodiment, such as the one shown in FIGS. 2 through 5, enclosure 4 has a generally circular radial cross section and a generally cylindrical shape. In alternate embodiments, enclosure 4 may be of any suitable shape that allows for the internal structure detailed below to fit inside enclosure 4 and perform as contemplated herein. Other exemplary geometries include a rectangular, square, or other radial cross section and that is appropriate as a light fixture itself or as a component in a light fixture. Enclosure 4 may also be large enough, for example, to accommodate multiple LEDs 1 in a spaced apart arrangement. More specifically, and only by way of example, enclosure 4 may be laterally elongated to provide for a spatial arrangement.

To meet desired interior and exterior surface area criteria, peripheral wall 5 may be square-corrugated, round-corrugated, undulated-corrugated, pleated, dimpled, or otherwise have a configuration intended to substantially increase the internal and external surface area of peripheral wall 5. As used herein, the terms “corrugated,” “pleated,” “undulating,” and “dimpled” and other similar terminology are intended to describe a structure based on its visual appearance rather than suggest, imply or require a specific technique of manufacture or fabrication.

Peripheral wall 5 may be constructed from a thermally conductive material such as metal or a material generally considered to be non-thermally conductive, such as plastic. Other suitable materials may include, but are not limited to, fiberglass and composite materials. Peripheral wall 5 may be formed from sheet stock, machined, drawn, extruded, cast, molded, or vacuum formed. In addition to its function as part of the heat exchange system 100, peripheral wall 5 may serve as a structural component for the heat exchanger system 100, a structural component for a light fixture, as part of and installation mechanism, and may also function as a design or aesthetic element of a light fixture.

In an exemplary implementation of the heat exchange system 100, enclosure 4 (shown in FIGS. 2 through 5) may be fabricated as an eight inch diameter pleated cylinder with the material forming peripheral wall 5 having a thickness of about 0.010 inch. In this example, the enclosure 4 is configured so as to achieve a desired light weight and still be reasonably compatible with manufacturing processes.

As shown in FIG. 2, top 6 forms a top of enclosure 4. The top 6 may include light fixture mounting apparatus formed thereon or therein. The top 6 may also include at least one additional surface area increasing structure such as fins to enhance thermal management. Electronics to power, drive, and/or control the LEDs and/or the fan may also be mounted on top 6.

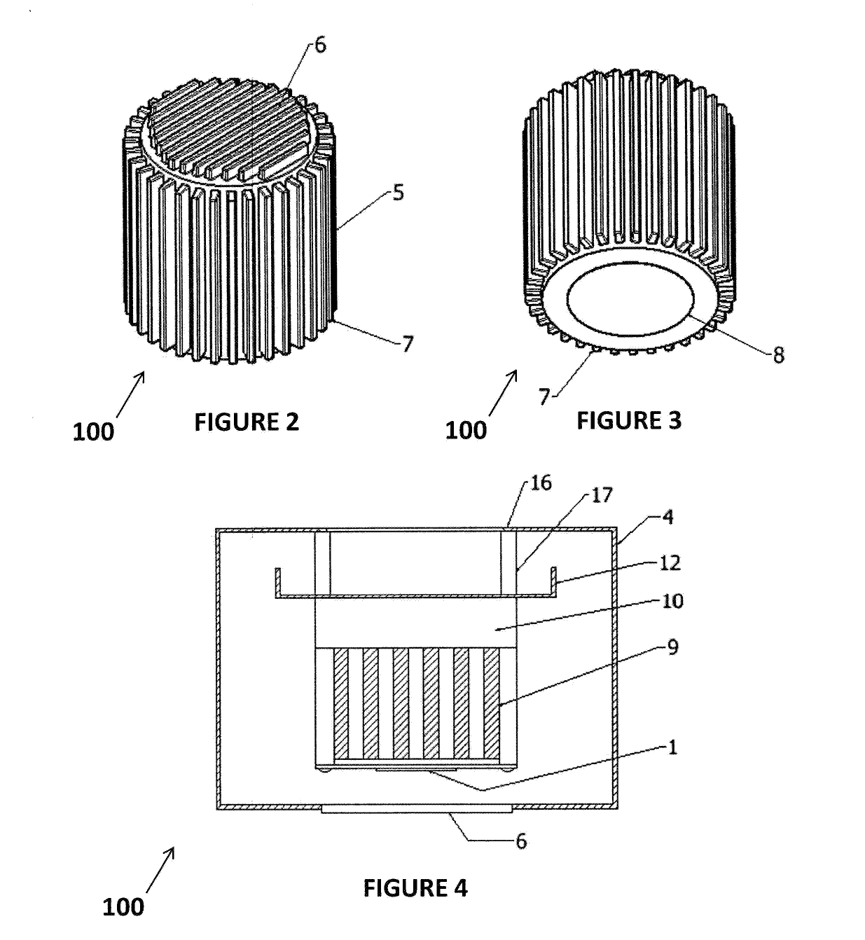

As shown in the example depicted in FIG. 3, bottom 7 forms a bottom of enclosure 4 and has a light output opening or optic 8. Top 6 and bottom 7 may be made of any suitable material and are preferably constructed from metal, fiberglass, a composite material, and/or plastic and may be formed from sheet stock, drawn, extruded, cast, stamped, or molded. Top 6 and bottom 7 may be secured to peripheral wall 5 by means or crimping, tabs and slots, adhesive, screws, press fitting, or in any manner deemed appropriate for securing the two components together.

FIG. 4 is an axial cross-sectional schematic illustration of the embodiment shown in FIGS. 2 and 3. In this example, LEDs 1 are mounted to heat sink 9 which is attached to fan 10. Generally, commercially available fans 10 and heat sinks 9 have pass through holes and/or threaded holes for conventional screw assembly. Accordingly, a variety of commercially available components may be used.

Exemplary components for the fan 10 include high quality DC ball-bearing fans that can be operated at low voltage and very low speed with a noise level less than 20 dB, well below the 24 dB class A sound level required of existing fluorescent-fixture ballasts. A device operating below 20 dB is generally considered inaudible from one meter away even in a quiet room.

Test reports for brushless direct current ball-bearing fans indicate life expectancies of as much as 50,000 hours or more in an elevated temperature environment. That is, such fans exhibit life expectancies about equal to or greater than LEDs. It should be emphasized that operating such fans at reduced speed can further increase life expectancy by as much as fifty percent.

Advantageously, dirt and/or moisture ingress is not a significant issue in most indoor lighting fixtures mounted more than four feet from the floor in typical commercial or institutional spaces whereas industrial and outdoor lighting fixture applications do face debris and water ingress or build-up. In any event, a closed system, that is, a sealed light fixture or at least a sealed assembly in a light fixture substantially limits or eliminates dust and/or water ingress and build-up.

FIG. 6 depicts a pin-type heat sink 9 of a type that may be used in heat exchange system 100. Other types of heat sinks 9 such as fin type may also be used. FIG. 7 depicts a fan 10 of a type that may be used heat exchange system 100. Heat sink 9 and fan 10 are shown mated in FIG. 8.

LEDs 1 may be mounted on a printed circuit board (PCB). In some embodiments, a PCB with a metal core is used to maximize thermal conductivity. In these embodiments, the printed circuit board may be mounted on heat sink 9 or, if LEDs 6 are in a package or module configuration, LEDs 1 may be mounted directly to heat sink 9. Heat sink 9 may be constructed of a material having a high thermal conductivity such as aluminum. LEDs 1 and heat sink 9 may be mated in such a way as to maximize thermal conductivity. Generally, LEDs 1 are positioned within enclosure 4 so as to work effectively with opening or optic 8.

Generally, heat sink 9 is sized so as to fit within enclosure 4 and so that there is suitable space between the sides of heat sink 9 and the inside of peripheral wall 5. In some embodiments, heat sink 9 is located within enclosure 4 and spaced apart from the interior of peripheral wall 5. Heat sink 9 may include a plurality of surface area increasing structures such as fins or pins and may be made of heat sink materials such as aluminum or copper. In some embodiments, heat sink 9 may be made of thermally conductive plastic. Aspects of the heat sink 9 may be carefully engineered to provide for efficient thermal transfer. For example, the materials chosen for fabrication of the heat sink 9 the geometry of the pins or fins as well as the spacing and sizing of these structures and other aspects such as air flow over the heat sink 9 may be considered in design of the heat sink 9.

An example of a suitable off-the-shelf heat sink 9 is Model CSL16070MP made by Cooliance Inc. Another example of a suitable off-the-shelf heat sink 9 is a finned heat sink for half brick DC/DC converters made by Aavid Thermalloy. In the example of FIG. 4, heat sink 9 has fins extending away from the structure upon which LEDs 1 are mounted.

Fan 10 may be mounted on the top of heat sink 9 as shown in FIG. 8. Fan 10 may be a conventional electronics cooling box fan. In some embodiments, the fan 10 is a long-life, ball bearing, brushless, DC version of a box fan. An example is Model 4710KL-04W-B10-E00 manufactured by NMB. As shown in FIG. 4, in one embodiment, fan 10 may be mounted directly to heat sink 9. Fan 10 may be powered by a direct current source. Speed of the fan 10 may be fixed. In some embodiments, speed of the fan may be a function of the temperature of the light emitting means, and/or a function of the light intensity output of the light fixture. For example, at higher light levels or higher temperatures, the speed of fan 10 may be higher and at lower light levels or lower temperatures, the speed of fan 10 may be lower.

In one embodiment, fan 10 is positioned so that the fan 10 blows air 14 into the pins or fins of heat sink 9, perpendicular to the heat sink base from which the pins or fins protrude. Relatively cool air is drawn into fan 10 and directed against the heated pins or fins of heat sink 9, which have been heated by LEDs 1, and then the hot air exits fan 10 generally transversely toward the cool outside pleated walls of the enclosure 4. This is different from typical air flow “across” heat sink fins (called “lateral” air flow). In this configuration, air is directed “into” the fins in a way known that may be referred to as “impulse cooling.” Generally, it is believed that impulse cooling results in desirable, higher air turbulence.

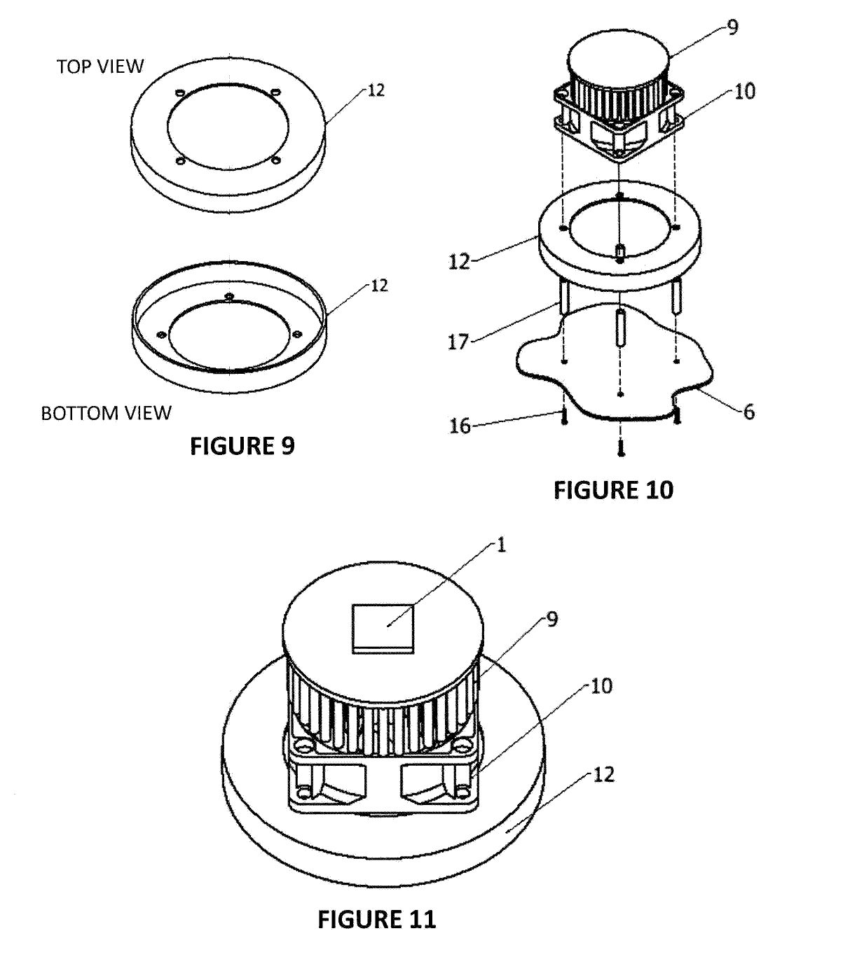

In some embodiments, and as shown in FIGS. 9, 10 and 11, baffle 12 may be mounted on top of fan 10 to direct air flow. FIGS. 10 and 11 show, respectively, an exploded view and a assembled view of an embodiment of the baffle 12 as used with fan 10 and heat sink 9. In the exploded view, screws 16 and spacers 17 are used to attach spacers 17 to baffle 12, and then to the mounting holes of fan 10. The screws 16 may also secure heat sink 9 to the assembly. The other end of spacers 17 may abut the inside of top 6 to position and fasten the assembly of LEDs 1, heat sink 9, fan 10, baffle 12 to top 6 of the enclosure 4, such as by use of the screws 16 or an equivalent fastener.

Baffle 12 may be fabricated from tubing or sheet stock or any other reasonably rigid material such as fiberglass, composite materials, card stock, cardboard, and/or plastic. Baffle 12 may be formed into a suitable size and shape for the fan opening. Baffle 12 may also be textured or shaped with undulations, dimples, corrugations, and/or pleats to further influence air flow. Baffle 12 may be secured to the fan 10 or to the inside of peripheral wall by use of mechanical structures or fittings.

The combination of size, shape and position of baffle 12 causes heated air to travel along an inner surface of peripheral wall 5 before being drawn back into the open end of baffle 12. This also causes reduction in mixing of the heated air exiting heat sink 9 with much cooler air being drawn into fan 10. Such reduction is desirable as mixing compromises overall cooling performance and reduces the potential power rating of the fixture. The degree to which baffle 12 is needed to prevent mixing of hot and cool air is dependent on the actual form factor of enclosure 4: the relationship of length, width and height. Some combinations may exhibit enough wall-surface turbulence and complete internal air circulation that mixing is not an issue. However, in one example, if enclosure 4 were to be six inches in diameter and sixteen inches long, a long cylindrical baffle 12 might be advisable or necessary to ensure that heated air is circulated to the coolest, most distant part of the enclosure before being drawn back, as cooler air, into the fan.

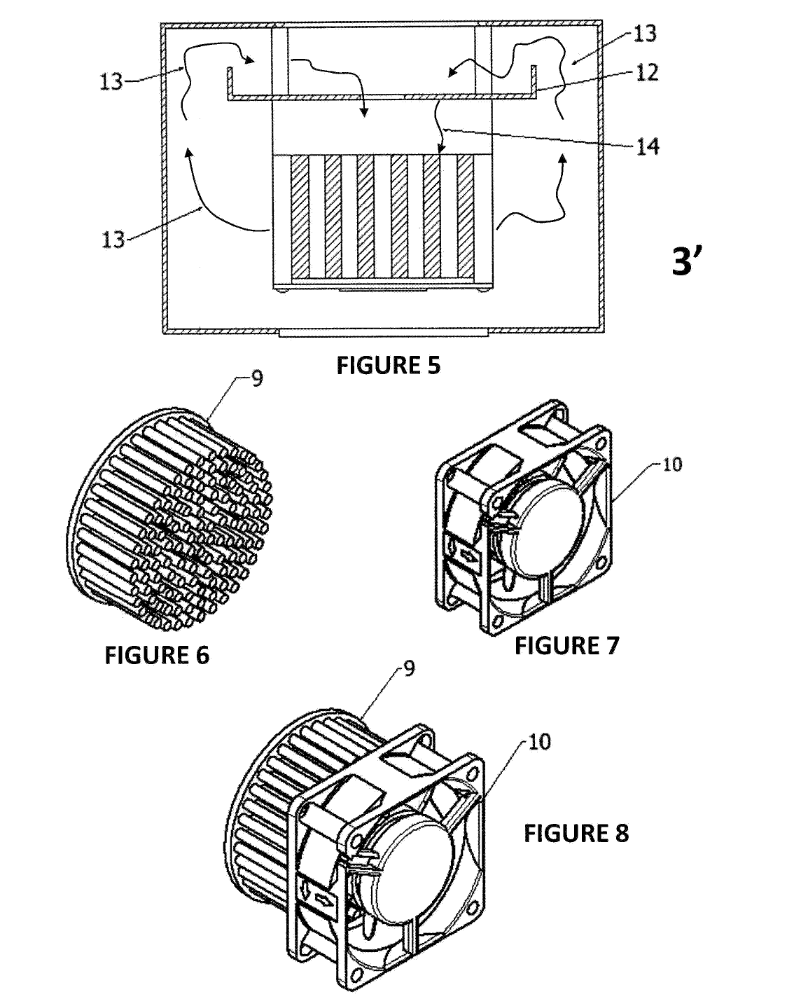

FIG. 5 is an axial cross-sectional view of the heat exchange system 100 shown in in FIGS. 2 and 3. FIG. 5 shows direction of airflow generally without showing all the vagaries influenced by the internal structure of the enclosure. In this example, fan 10 pulls air in channel 14 and directs it into the heat sink 9 pins or fins and then out into the enclosure 13 and then up past the baffle 13′ and then into the inside of baffle 12 and back into intake of the fan 10. The air flow achieved in this embodiment, which may be considered to be a circulating loop, provides adequate movement of air to transfer heat from heat sink 9 to the air inside 3 of enclosure 4 to the peripheral walls 5 of enclosure 4 and ultimately to ambient air 3′.

The assembly of LEDs 1, heat sink 9, fan 10, and baffle 12 (if used), may be held in a fixed position relative to one another and within and spaced apart from in interior of enclosure 4 by use of brackets, spacers, fasteners or other apparatus which suit the given design and manufacturing objectives. Standard existing mounting holes in the housing of fan 10 along with appropriately positioned holes in heat sink 9 and baffle 12 can facilitate such positioning options. The mechanical structure and fastening of components may be of conventional means well known to those of skill in the lighting fixture industry.

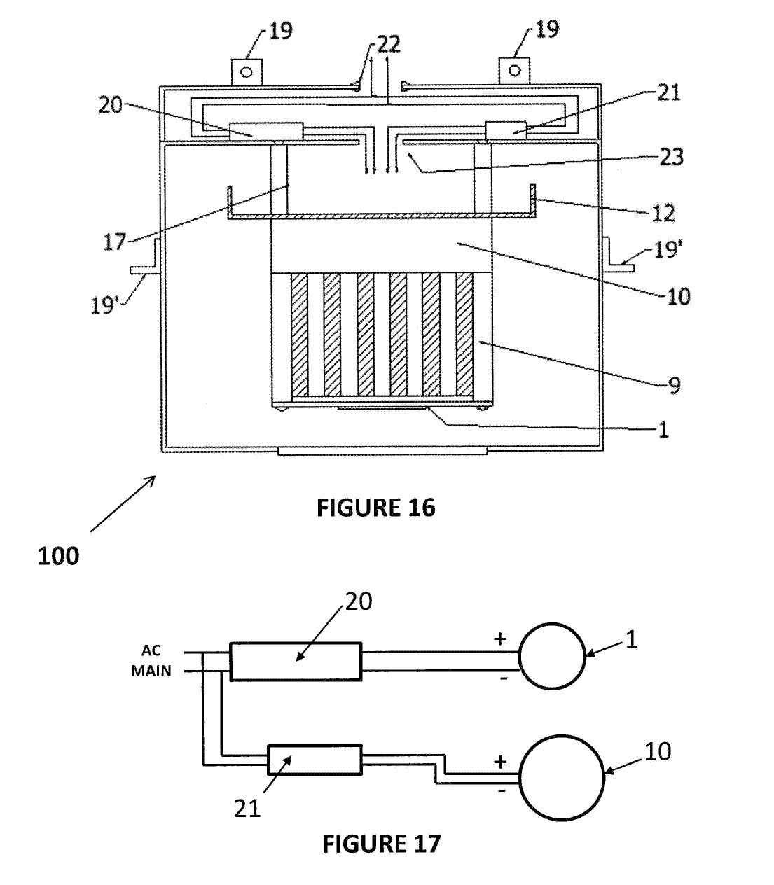

Exemplary and alternately mounting brackets 19 and 19′ are illustrated in FIG. 16. Such brackets may be used to mount the heat exchange system 100 within a light fixture or as a light fixture.

Without moving air within enclosure 4, enclosure 4 would be hotter near heat sink 9 and progressively cooler the farther away a given wall surface is from the heat source (LEDs 1). Temperature differentials in such a “static” system are the result of heat transfer inefficiencies in the system. In a traditional cast or extruded aluminum heat sink system, such heat-transfer inefficiencies are dealt with by increasing the total equivalent cross-section of metal connecting the heat source to remote areas of the heat sink. Such a cross-section-based method of increasing heat transfer and minimizing what is known as “spreading thermal resistance” can only be achieved by substantial increase in size, weight and cost.

When LEDs 1 are at operating temperature, because the exterior of enclosure 4 is in contact with ambient air, it is always cooler than heat sink 9. Whenever such a temperature differential exists, there is an opportunity for heat exchange. Moving a substantial portion of the heated air across the cooler inside walls of enclosure 4 will effect the heat exchange. The degree and efficiency of the heat exchange is determined by, among other things: the surface area of the peripheral wall 5 of the cooler enclosure 4 as well as a percentage of the heat from can be moved across peripheral wall 5. The efficiency of the heat exchange will also govern and amount of heated air that is recycled to the intake side of fan 10. The ability of heat sink 9 to cool LEDs 1 is limited, to a substantial degree, by the temperature of fan 10 intake air.

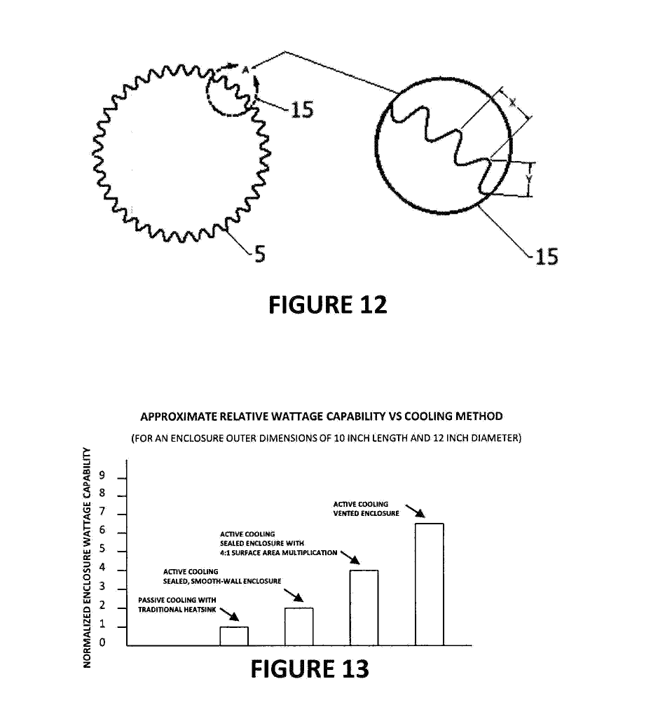

To exhibit a desired level of performance benefit in an airtight enclosure 4, the fan 10 should receive air 3 that has been substantially cooled in spite of absence of access to outside air 3′. In the embodiment shown in FIG. 12, peripheral wall 5 of enclosure 4 is shaped to substantially increase surface area of the interior and the exterior of enclosure 4. In one embodiment, this is accomplished by pleating (as shown in FIG. 12). By forming peripheral wall 5 of enclosure 4 in this or a similar manner, the overall surface area of enclosure 4 can be significantly increased in nearly direct proportion to the ratio of 2X to Y (Y being a distance between successive peaks of each pleat and X being a length of each sloping leg of each pleat). For the system to achieve a desired level of performance, increased surface area should be provided on both the inside and outside of peripheral wall 5 so that the surface area receiving heat from the internal ambient air 3 substantially equals the surface area transferring heat to the external ambient air. This results in the warm-air-to-cool-air thermal resistance of peripheral wall 5 to be substantially same across peripheral wall 5.

A relatively thin material, regardless of whether it is metal, plastic or composite material, can be an excellent heat exchanger if the surface area is large enough. In practice, the choice of material used in peripheral wall 5 may be influenced by which material offers the best combination of low fabrication cost and system assembly options. In some embodiments, pleating or corrugating enclosure 4 with a high 2X-to-Y ratio can achieve substantial heat exchange without significantly increasing the size of the overall light fixture dimensional envelope within which the heat exchanger system 100 be used. In such a system, the temperature of LEDs 1 may be determined by the total thermal resistance, R-T, from the heat-sink mounting surface to the ambient air. R-T has two major parts: theta-1, the thermal resistance from the mounting surface of LEDs 1 to the air within the enclosure; and, theta-2, the thermal resistance from the internal air to the external air. Achieving a low theta-1 may include, for example, mounting the LEDs 1 to large heat sinks whose fins are exposed directly to outside ambient air (so that in fact there is no theta-2 at all) or to mount the LEDs 1 onto a smaller heat sink and to employ moving air, typically by use of a fan to improve the efficacy of the smaller heat sink.

The heat exchange system 100 can result in more than a 4:1 reduction in size and weight of thermal management system components for a given power and lumen level as compared with traditional passive heat sink approaches without the problems of vented active cooling systems as noted herein.

In some embodiments, such as for stylistic purposes, it may be desirable to minimize or eliminate visual evidence of the pleated or corrugated peripheral wall 5. In such embodiments, enclosure 4 may be placed in a decorative, non-airtight outer enclosure only slightly larger than that of the enclosure 4. If such an outer cover has some appropriately positioned openings, a minimal amount of “chimney effect” air circulation will generally provide adequate cooling because of the very large heat exchanging surface area exhibited by the pleated structure.

FIG. 13 shows the relative power and light output believed to be achievable for an airtight and vented fixture of approximately the same outer dimensions. The vented approach, while functionally very good, is generally not acceptable for a number of outdoor applications as well as a majority of high power indoor applications. It can be seen that while the pleated structure does not match a fully vented active-cooled enclosure 4, there can be as much or more as a 4:1 reduction in size and weight for a given wattage and corresponding lumen output.

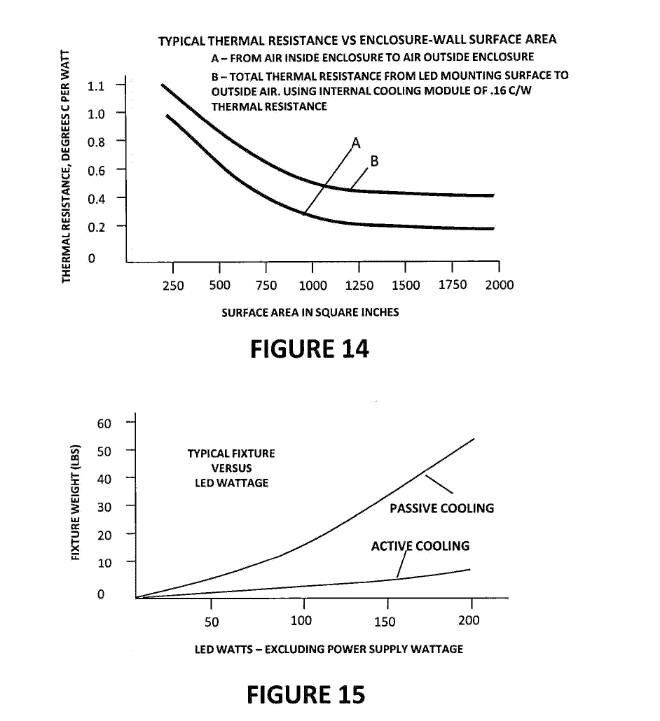

FIG. 14 is a graph depicting what happens when a low-thermal-resistance fan/heat sink combination is placed within a sealed enclosure 4. With a small-volume enclosure of about 200 square inches of surface area, and a fan heat sink having a thermal resistance of 0.15 degrees Celsius per watt, the exhibited thermal resistance to the ambient is about 0.75 Celsius per watt. This means that 0.60 of that is attributed solely to the thermal resistance between the inside air and the outside air. As a size of the enclosure 4 increases and reaches more than 6,000 square inches, the enclosure 4 becomes a virtual “room,” with a room-like ambient temperature and the thermal resistance of the inside air to the “real” outside air becomes negligible. As a result, the net thermal resistance is close to the same 0.16 C per watt thermal resistance as measured in free air.

At certain power levels, making use of this curve can be useful even without employing corrugated walls. That is, a substantial surface area can be achieved by a low cost, very light weight, thin-walled plastic enclosure, which, together with the fixed fan/heat sink configuration, exhibits relatively low thermal resistance, at a fraction of the weight needed for a traditional metallic heat sink. This is to say that at certain power levels, the choice of corrugated or non-corrugated enclosure walls can be best determined by the weight and stylistic objectives and constraints as guided by the relationships of FIG. 13. While FIG. 14 is based on a particular fan/heat sink combination, the fundamental relationships and shape of the curve will be similar for any type of fan/heat sink combination inside a sealed container as long as that combination employs the impulse perpendicular) cooling configuration of FIG. 2.

FIG. 15 is an exemplary weight comparison of a passive cooling system relying on a heat sink and an active cooling system as provided herein for LED lighting at the given wattage. The active cooling system as provided herein includes an enclosure 4 that includes a pleated peripheral wall 5 of a thickness of about 0.040 of an inch of plastic and a 0.15 Celsius per watt fan 10 and heat sink 9 combination. The passive cooling system generally includes a passively cooled cast metal heat sink to achieve the same power level. It can be seen that as power levels get above 50 watts, the metal heat sink and the two-stage heat exchanger start to diverge in weight significantly even though their respective outer volumetric envelopes (length, width and height outermost dimensions) may not be that different.

In virtually all LED light fixtures, it is necessary to incorporate a power supply to regulate LED current. Such a power supply typically consumes from 10-20% of total light fixture power and a result generates a nearly proportional amount of heat. That is, a light fixture rated at 200 watts might typically have a power supply generating about 20-30 watts of heat. In addition, a power supply and a controller for fan 10 are required. In some embodiments, it is desirable to have such power supplies and controllers mounted outside of enclosure 4, either on the outside, for example on top 6, or remotely so that power supply and controller heat is not contributing to the heat generated by LEDs 1. However, it is possible to have power supplies and/or controllers within enclosure 4, subject to the overall heat transfer capabilities of the heat exchange system 100 being adequate to handle the additional power supply heat.

FIG. 16 shows an embodiment of the heat exchange system 100 that is similar to that shown in FIG. 4. In addition, an AC mains operated power supply 20 and a small AC mains operated control module 21 which supplies power for the fan are shown mounted in an auxiliary compartment 24 structure on top 6 outside of enclosure 4 but which may be inside of a light fixture employing the heat exchange system 100. Holes 22 and 23 are provided for wiring to pass and hole 23 may have a grommet to preserve the closed nature of enclosure 4. This arrangement keeps the two modules 20 and 21, to a substantial degree, from injecting heat into enclosure 4. Auxiliary compartment 24 can be vented since there is not issue there with effect of air or moisture free on fan performance. It is important to note that auxiliary compartment 24 may not be necessary or required and modules 20 and 21 mounted externally.

It should be recognized that there are many ways to mount such power supplies and control modules. Therefore, specific arrangements and the embodiment depicted herein are merely illustrative and are not limiting of the heat exchange system 100.

FIG. 17 shows a simplified representation of connective wiring for the power supply 20 and control module 21 of FIG. 16 to the LEDs 1 and fan 10. Control module 21 might perform other supervisory functions such as dimming, occupancy sensing, or wireless control.

Having thus introduced aspects of the heat exchange system 100 additional advantages and aspects are now discussed.

Among other things, the heat exchange system provides a cooling system for LED light fixtures that overcomes the number of deficiencies in the prior art. The heat exchange system includes relatively simple and inexpensive components; an active cooling system that results in substantially improved heat transfer; protection against debris, dust, moisture, and/or water ingress or build up issues that impact performance of LEDs; all of which provide for use of higher power LEDs and/or greater number of LEDs, reductions in system size and cost and therefore improved performance for a variety of system parameters.

Generally, improved performance is accomplished by providing a heat exchange system for an LED light fixture that includes an enclosure, a heat sink positioned inside of and spaced apart from said enclosure, and a fan positioned inside of and spaced part from said enclosure. Various additional embodiments may include but are not limited to: a substantially closed enclosure; an enclosure that provides the exterior of the light fixture; an enclosure having a substantial inside surface area and a substantial outside surface area such as by incorporation of a pleated structure or a corrugated structure; LED light emitters, heat sink and fan positioned inside of and spaced apart from the enclosure; varying the speed of said fan as a function of the temperature inside said enclosure and/or the light intensity output of the light fixture; and, a baffle positioned inside of and spaced apart from the enclosure to direct air flow within the enclosure.

As a matter of convention, it should be noted that the term “open” is generally with reference to the heat exchange system with regards to an external environment. Similarly, the term “closed” generally refers to the heat exchange system being substantially separated from an external environment. A degree of separation in a closed system is to be judged by the standards of a user, designer, manufacturer or other similarly interested party. A “closed” system may range from substantially closed to airtight. In a closed system, any air exchange between the inside and outside is minimal and debris and water ingress is substantially precluded.

In addition, relative terminology as may be used herein, such as “very large” and “substantial,” should be considered with regards to equivalent structures in the prior art. For example, an enclosure that exhibits substantial surface area is in comparison to prior art enclosures. An enclosure that exhibits very large surface area for its size is also in comparison to prior art enclosures (e.g., a generally smooth enclosure that generally does not include surface features such as pleating or corrugation).

Further, as discussed herein, the term “pleating” and other related terminology such as “pleats,” generally refers to incorporation of a plurality of folds. Accordingly, “pleated material,” such as in the enclosure, exhibits sharp peaks and sharp valleys in the material. Similarly, the term “corrugated” and other related terminology such as “corrugations,” generally refers to incorporation of an undulating surface. Accordingly, “corrugated material,” such as in the enclosure, exhibits a plurality of smooth hills and smooth valleys in the material.

It should be recognized that the teachings herein are merely illustrative and are not limiting of the invention. Further, one skilled in the art will recognize that additional components, configurations, arrangements and the like may be realized while remaining within the scope of this invention. For example, configurations of enclosures, fan(s), heat-sinks, LEDs, circuitry and the like may be varied from embodiments disclosed herein. Generally, design and/or application of components of the heat exchange system is limited only by the needs of a system designer, manufacturer, operator and/or user and demands presented in any particular situation.

Various other components may be included and called upon for providing for aspects of the teachings herein. For example, additional materials, combinations of materials and/or omission of materials may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

In the present application a variety of variables are described, including but not limited to components, conditions, and performance characteristics. It is to be understood that any combination of any of these variables can define an embodiment of the invention. For example, a combination of a particular material, with a particular component or set of components, under a particular range of a given environmental condition, while not be expressly stated, is an embodiment of the invention. Other combinations of articles, components, conditions, and/or methods can also be specifically selected from among variables listed herein to define other embodiments, as would be apparent to those of ordinary skill in the art.

Therefore, while the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A heat exchange system for a light emitting diode (LED) light fixture, comprising:
an enclosure at least partially surrounding at least one LED;
a heat sink positioned inside of and spaced apart from said enclosure, the heat sink configured to transfer heat away from the at least one LED; and
a fan positioned inside of and spaced part from said enclosure, the fan configured to transfer heat away from the heat sink.

2. The heat exchange system of claim 1, wherein the enclosure is substantially closed from an external environment.

3. The heat exchange system of claim 1, wherein the enclosure forms an exterior of a light fixture.

4. The heat exchange system of claim 1, wherein the enclosure comprises a peripheral wall and the peripheral wall has a substantial inside surface area and a substantial outside surface area.

5. The heat exchange system of claim 1, wherein the enclosure comprises a peripheral wall and the peripheral wall has a very large internal surface area and very large exterior surface area for its size.

6. The heat exchange system of claim 1, wherein said enclosure comprises a peripheral wall and said peripheral wall has a very large internal surface area and very large exterior surface area for its weight.

7. The heat exchange system of claim 1, wherein the enclosure comprises a peripheral wall comprising a pleated structure.

8. The heat exchange system of claim 7, wherein the pleated structure comprises proportions 2X to Y, where Y is the distance between successive peaks and X is the length of each sloping leg.

9. The heat exchange system of claim 8, wherein the pleated structure comprises proportions greater than 2X to Y, where Y is the distance between successive peaks and X is the length of each sloping leg.

10. The heat exchange system of claim 1, wherein the enclosure comprises a peripheral wall comprising a corrugated structure.

11. The heat exchange system of claim 10, wherein the corrugated structure comprises proportions 2X to Y, where Y is the distance between successive peaks and X is the length of each sloping leg.

12. The heat exchange system of claim 11, wherein the corrugated structure has proportions greater than 2X to Y, where Y is the distance between successive peaks and X is the length of each sloping leg.

13. The heat exchange system of claim 1, wherein the at least one LED is mounted on one side of the heat sink and the fan is mounted one of on and proximal to an opposing side of the heat sink.

14. The heat exchange system of claim 1, wherein the fan is oriented to move air toward the heat sink.

15. The heat exchange system of claim 1, wherein the enclosure comprises a peripheral wall and the peripheral wall has a thickness less than about 0.05 of an inch.

16. The heat exchange system of claim 1, wherein the enclosure comprises a peripheral wall and the peripheral wall has a thickness less than about 0.025 of an inch.

17. A thermal management system for an LED light fixture, the system comprising:
a first heat exchanger to remove heat from LEDs to air within an enclosure that at least partially surrounds the LEDs; and,
a second heat exchanger to transfer heat from the air within the enclosure to air outside of said enclosure.

18. The system of claim 17, wherein the enclosure has very large interior surface area and very large exterior surface area.

19. The system of claim 17, wherein the enclosure has very large interior surface area and very large exterior surface area for its size and weight.

20. A heat exchange system for an LED light fixture, the system comprising:
an enclosure comprising a peripheral wall that comprises a pleated structure;
a heat sink positioned inside of and spaced apart from the enclosure;
a fan positioned inside of and spaced part from the enclosure and mounted one of on and proximal to a first side of the heat sink; and,
a baffle positioned inside of and spaced part from the enclosure and positioned one of proximal and abutting to the fan on the first side of the fan;
wherein heat exchange system is closed from an external environment.
